(19) United States
(12) Patent Application Publication
(10) Pub. No.: US 2019/0074741 A1
(43) Pub. Date: Mar. 7, 2019

(54) ROTOR FOR AN ELECTRICAL GENERATOR AND METHOD FOR ITS MANUFACTURING

(71) Applicant: VERTICAL WIND AB, Uppsala (SE)

(72) Inventor: Hans BERNHOFF, Uppsala (SE)

(73) Assignee: VERTICAL WIND AB, Uppsala (SE)

(21) Appl. No.: 16/080,538

(22) PCT Filed: Mar. 1, 2017
(86) PCT No.: PCT/SE2017/050194

§ 371 Date: Aug. 28, 2018

(30) Foreign Application Priority Data
Mar. 4, 2016 (SE) 1650287-4

(51) Int. Cl. H02K 1/30

(52) U.S. Cl. CPC H02K 1/30; H02K 15/03

(57) ABSTRACT

Provided is a rotor for an electric generator comprising a cylindrical casing part and a connecting structure to connect the casing to a rotor shaft. The structure comprises at least one plane disc composed of a plurality of plane disc elements which comprise disc elements that engage lockingly into each other, wherein a first and a second disc element comprise a complementary shape, where the two discs meet, with at least one protrusion on the first disc element and a corresponding number of recesses of the same shape at a complementary position on the second disc element. A protrusion on the first disc element engages a recess in the other disc element, where the protrusion has a varying width with a first portion at a distal end that is broader than a second portion proximal to a base of the disc element to create a shape-permanent locking engagement.

### CROSS-REFERENCE TO RELATED APPLICATION(S)

This application is a National Stage Application (filed under 35 § U.S.C. 371) of PCT/SE2017/050194, filed Mar. 1, 2017 of the same title, which, in turn claims priority to Swedish Application No. 1650287-4 filed Mar. 4, 2016 of the same title; the contents of each of which are hereby incorporated by reference.

### FIELD OF THE INVENTION

The present invention relates in a first aspect to a rotor for an electric generator comprising a cylindrical casing part and a connecting structure arranged to connect the casing part to a rotor shaft, which structure comprises at least a plane disc. The rotor according to the invention can be of the type with permanent magnets or with rotor poles. In a second aspect, the invention relates to an electric generator provided with such a rotor. In a third aspect, the invention relates to a method for manufacturing such a rotor.

### BACKGROUND OF THE INVENTION

The rotor of electric generators is conventionally a cylindrical steel structure on whose periphery the magnets are attached. Usually the steel structure constitutes a uniform body. The manufacturing of the rotor to a generator is normally costly and precision-demanding, especially in the case of large generators. Large generators, in the order of MW, also involve considerable problems and costs related to the transport. For inter alia these reasons there are examples of how a rotor of a generator in different ways is assembled from parts that can be transported separately. Such types of rotors are described in US 2014288267, CA 1104185, JP 2012249386 and CN 201414060.

### SUMMARY OF THE INVENTION

The object of the present invention is to achieve a rotor such that the manufacturing of the same can be done in a more rational way than in the conventional ways. The object of the invention is furthermore to achieve a manufacturing method that is correspondingly rational.

This object is achieved according to a first aspect of the invention by means of a rotor of the specified kind in the preamble to patent claim 1 that has the special features stated in the characterizing part of the claim. Thus, the disc of the rotor is composed of a plurality of plane disc elements that engage lockingly into each other in a puzzle-like manner implying that where a first and a second disc element meet these have a complementary shape with at least one protrusion on the first disc element and a corresponding number of recesses of a complementary shape and position on the other disc element, whereby a protrusion on the first disc element engages into a recess in the other disc element, which recess has the same shape as the protrusion and whereby at least one protrusion has a varying width with a first portion closer to the outer end of the protrusion that is wider than a second portion closer to the base part of the disc element—i.e. the part thereof that does not comprise protrusion—to provide shape-permanent locking engagement so that a joint is formed between the first and the second disc element.

The fact that the disc in this way is composed of a plurality of disc elements that have been puzzled together permits a simple and rational manufacturing compared to traditional technique, especially in case of large generators. By means of the protrusions and the recesses, a safe joint that keeps the disc together is ensured. The disc can be composed of disc elements with engaging protrusions/recesses thereof as well as of disc elements without such a profile. However, it is preferred that all disc elements of the disc are provided with protrusions/recesses.

According to a preferred embodiment, the disc is composed in sectors and comprises disc elements engaging into each other mainly along radial lines, whereby each of these disc elements is substantially sector-shaped. When the generator is not too large, such a sectioning of the disc is normally enough to benefit from the rationality profits of the invention.

According to a further preferred embodiment, the disc is sectorally as well as radially composed and comprises disc elements that engage into each other mainly along radial lines and disc elements that engage into each other along circular lines around the center shaft of the rotor or along tangential lines. Especially for larger generators it is an advantage that the disc in this way is divided into elements also in a radial direction.

According to a further preferred embodiment, at least some of the joints comprise a plurality of cooperating protrusions-recesses, wherein at least one of these cooperating protrusions-recesses has said shape-permanent locking engagement. With a plurality of mutual engagements the reliability of the joints and thereby the robustness of the disc increases. This especially applies if a plurality of the joints are provided with locking action, which therefore in many cases is preferable.

According to a further preferred embodiment, the protrusion of said shape-permanent locking engagement is substantially trapezoidal. The trapezoidal shape is the simplest shape that provides the specified relation and the locking action, and facilitates the manufacturing of the disc elements as well the joining thereof. Substantially, trapezoidal entails that it also comprises the case where the shape deviates somewhat from the purely mathematical trapezoidal shape, for example by rounded corners.

According to a further preferred embodiment, each disc element is provided with protrusions as well as recesses including in the same joint. This contributes further to strengthen the solidity of the joint, not least through the symmetry in the force absorption that is thereby achieved.

According to a further preferred embodiment, the recesses and protrusions included in the same joint of a disc element have mutually complementary shapes. This further increases the symmetry of the joint and increases its solidity.

According to a further preferred embodiment, a plurality of disc elements have the same shape and size. This permits a unitary manufacture of these disc elements, creates a mutual exchangeability when they are joined and provides an even distribution of the positions of the joints on the disc. Hence the manufacture becomes even more rational and the disc becomes maximally stable. These advantages become more clear the more disc elements that are consistent with each other in this way. In a disc comprising, for example, a radially inner and radially outer group of disc elements, the disc may advantageously be designed so that all radially outer discs are consistent with each other and all radially inner discs are consistent with each other.

According to a further preferred embodiment, at least some of the disc elements exhibit at least one through-hole. It is normally desirable to keep down the mass of the disc as far as possible. To make holes in the discs is a simple way to achieve this. The holes are made in as many of the disc elements as permitted by the solidity, and one and the same disc element can have several holes.

According to a further preferred embodiment, the connecting structure comprises two discs at an axial distance from each other. For larger generators this results in increased stability. Preferably both discs are assembled from disc elements according to the invention. Preferably the discs are substantially identical.

According to a further preferred embodiment, the discs are located at an equal distance from a respective axial end of the rotor and said distance is less than the axial distance between the discs.

According to a further preferred embodiment, the rotor comprises a plurality of radially extending partition walls that connect the two discs. This stabilizes the rotor.

According to a further preferred embodiment, screw joints connect the disc elements with each other. The screw joints result in a complementary reinforcement that increases the stability of the rotor.

According to a further preferred embodiment, the casing part comprises at least one casing layer, which casing layer is composed of a plurality of arc-shaped casing parts that engage lockingly into each other in a puzzle-like manner, implying that where a first and a second casing part meet, these have a complementary shape with at least one protrusion on the first casing part and a corresponding number of recesses of a complementary shape and position on the second casing part, whereby a protrusion on the first casing part engages into a recess in the second casing part, which recess has the same shape as the protrusion and whereby at least one protrusion has a varying width with a portion closer to the outer end of the protrusion that is wider than a portion closer to the base part of the casing part—i.e. the part thereof that does not comprise protrusion—for providing a shape-permanent locking engagement so that a joint is formed between the first and the second casing part.

This means that the principle to design the disc of the rotor composed of disc elements also applies to the casing part that here is composed in a corresponding way, which provides advantages of a similar kind also for the casing part. The whole rotor can thus be manufactured in a rational manner. The casing part can be assembled of casing parts that exhibit such complementary protrusions/recesses and of casing parts that lack such profile. Alternatively, all casing parts can be provided with protrusions/recesses.

According to a further preferred embodiment, the casing part comprises a plurality of said casing layers, which abut each other.

The casing part normally needs to have a relatively large thickness, radially seen. By designing the casing part in several layers, each layer can be designed with such a small thickness that it does not cause any problems to manufacture casing parts with the special profile that is needed for the locking joints.

According to a further preferred embodiment, a joint of a casing layer is thereby located displaced in the peripheral direction in relation to the joints of the closest adjacent casing layer. The casing part thereby becomes stronger than if the joints would be at the same location in the peripheral direction.

According to a further preferred embodiment, the screw joints connect the casing parts with each other. By also reinforcing the joint of the casing part in this way, the casing part also becomes more stable.

According to a further preferred embodiment, the rotor comprises a plurality of circumferentially distributed, removable dismantling joints. Dismantling joints in this application refer to joints between parts of which the rotor is composed and that can be detached by simple measures so that the rotor is divided into parts. This simplifies transport of the rotor when it can be divided in this way. The dismantling joints may consist of some of the joints of which the rotor according to the invention is composed. It is then primarily a question of radially directed joints that connect sector-shaped disc parts. The number of dismantling joints may, for example, be three. They are suitably radially directed and are preferably evenly distributed circumferentially.

According to a further preferred embodiment, the diameter of the rotor is larger than 2 m. The advantages with a rotor composed according to the invention are greater the larger the generator is. Thus, rotors with a diameter over 2 m, for example in the interval 2-10 m, is a particularly important application.

According to a second aspect of the invention, the stated object is achieved by a generator provided with a rotor according to present invention, especially according to some of the preferred embodiments thereof, which give corresponding respective advantages.

According to a third aspect of the invention, the stated object is achieved by a method of the kind specified in the preamble to patent claim 21 that comprises the measures stated in the characterizing part of the claim.

The method thus comprises the steps of:

manufacturing a plurality of plane disc elements with a respective profile so that the disc elements can be put together like a puzzle, where a first and a second disc element has a complementary shape in that the first disc element is manufactured with at least one protrusion and the second disc element is manufactured with a corresponding number of recesses of the same shape and a complementary position and wherein at least one protrusion has a varying width with a first portion closer to the outer end of the protrusion that is wider than a second portion closer to the base part of the disc elements, and which disc elements together form a circular disc with a center hole,

joining the disc elements into a circular disc by inserting protrusions in complementary recesses in a puzzle-like manner so that they engage lockingly into each other in a shape-permanent joint,

attaching a rotor shaft in the hole, and

attaching a cylindrical body around the disc for the formation of a casing part.

This way of manufacturing a rotor provides advantages of a kind corresponding to those as specified above for the invented rotor.

According to a preferred embodiment of the invented method, the disc elements are manufactured by cutting them out from plane discs. The precision that is required to create the profiles with protrusions and recesses is normally easier to achieve by a cutting operation than by conceivable alternative methods.

According to a further preferred embodiment, the disc elements are thereby cut out by laser cutting. By laser cutting it is possible to achieve a very good precision, down to the order of 0.01 mm. Discs with a thickness up to one or a few tens of mm can be cut out with this precision without any subsequent processing. The good fit that is thus achieved is valuable when the disc elements are to be puzzled together and simplifies this. The stability of the disc also becomes better, the better the disc elements fit into each other.

According to further preferred embodiments, the rotor is manufactured in such a design as disclosed by any of the above mentioned preferred embodiments thereof. This entails advantages of a kind corresponding to those as described above for respective embodiment of the rotor.

It should be understood that further advantageous embodiments may consist of any possible combination of features in the above described embodiments and of any possible combination of these features with features that are clear from the description of the embodiments below.

### BRIEF DESCRIPTION OF THE DRAWINGS

Below is a description of, as examples, embodiments of the invention with reference to the enclosed drawings, in which:

FIG. 1 is a perspective view of an example of a generator according to the invention;

FIG. 2 is a perspective view of a part of the rotor in the generator in FIG. 1;

FIG. 3 is a perspective view of a detail in FIG. 2;

FIG. 4 is an end view of a part of a detail in FIG. 2; and

FIG. 5 is a schematic end view of a disc of a rotor according to an alternative embodiment.

### DETAILED DESCRIPTION OF THE INVENTION

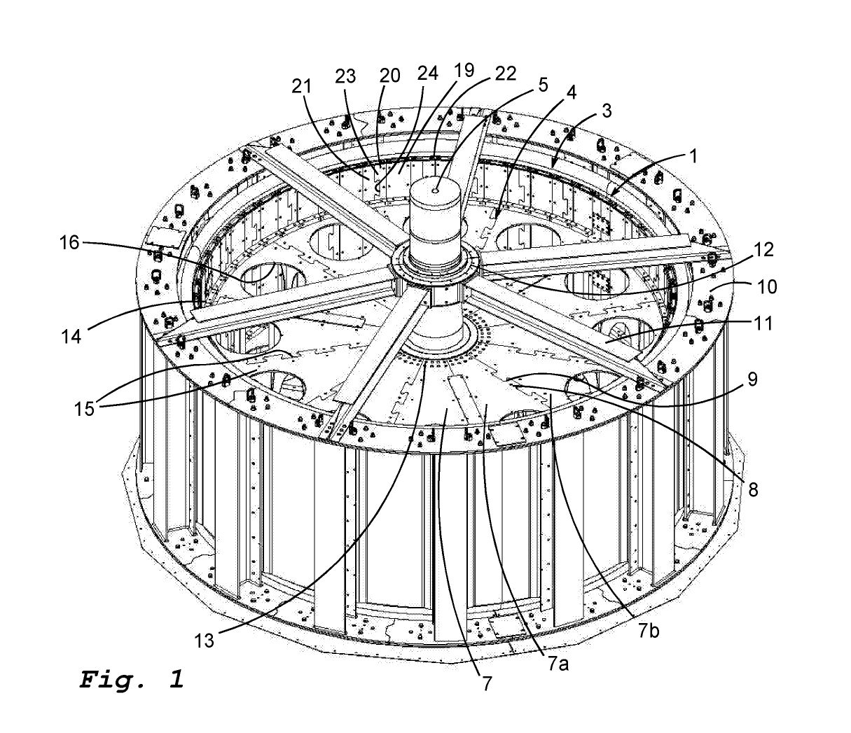

The generator in FIG. 1 has an internal rotor 1 and an external stator 10. The rotor 1 is rotatably attached to the rotor shaft 5. The stator 10 is rigidly connected to the bearing 12 of the rotor shaft 5 via six beams 11. The rotor 1 is composed of a casing part 3 and two circular discs 4, of which only the upper one is shown in the figure. The second disc is located under the upper one in the figure. On the periphery of the casing part 3, permanent magnets are arranged for cooperation with the stator windings. The two discs 4 form a structure that connects the casing part 3 to the rotor shaft 5. Each disc is composed of twelve substantially sector-shaped disc elements 7, which are rigidly and shape-permanently connected to each other. The disc 4 is connected to the rotor shaft 5 by an inner screw joint 13 and connected to the casing part 3 by an outer screw joint 14. Each disc element 7 is attached by means of the screw joints 13, 14 to the rotor shaft 5 and the casing part 3. The disc elements 7 are mutually connected to each other partly by hooking into each other by complementary protrusions 8 and recesses 9 that engage into each other, so that a shaped-permanent joint is established. As reinforcement a screw joint 15 is also provided. Each disc element 7 has a through-hole 16.

The casing part 3 is composed in a similar way. It consists of a plurality of axially elongated casing parts 19, 20, 21 of three different embodiments. A first series of casing parts 19 has rectilinear lateral edges, a second series of casing parts 20 has a rectilinear lateral edge in one direction and a profiled lateral edge in the other direction and a third series of casing parts 21 has a profiled lateral edge in one direction and a rectilinear lateral edge in the other direction. The casing parts 21 of the third series have a larger width in the peripheral direction than the casing parts 20 of the second series. The profiled lateral edge of the casing parts 20 of the second series is provided with protrusions 23 and recesses 24 that engage into complementary protrusions and recesses on the profiled lateral edge of the casing parts 21 of the third series. Hence a shape-permanent joint is formed between them. The casing parts of the first series 19 are connected to the rectilinear lateral edges of the casing parts 20, 21 of the second and the third series by a respective screw joint 22, which comprises a supporting strip on the outside.

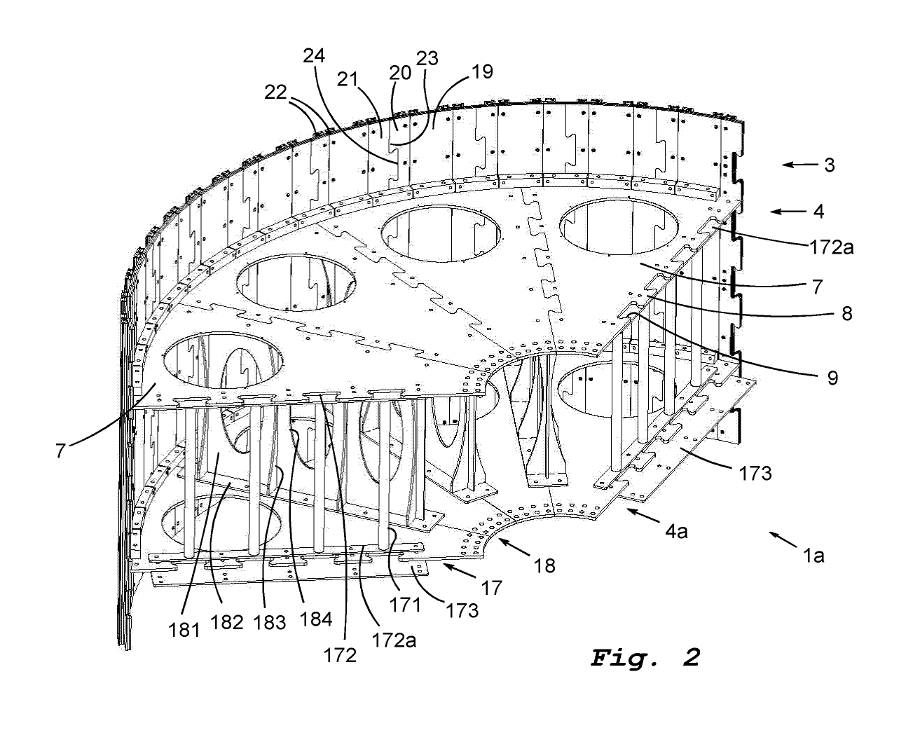

The design of the rotor is shown in more detail in FIG. 2 that shows a perspective view of a part 1a of the same. The part 1a consists of ⅓ of the rotor 1 and thus comprises four of its disc elements 7. In this figure also a corresponding part of the lower disc 4a is shown. The rotor is arranged to be easily assembled and disassembled in these three parts in order to facilitate transportation etc.

Between the upper 4 and the lower 4a disc, there are stiffening connecting devices 17, 18 that connect the discs to each other. These are of two different embodiments. One of the embodiments 17 is arranged at the connection ends of the rotor part 1a towards the other rotor parts. It consists of two rows with four axially directed rods 171 that, at each end, are attached at radially extending strips 172, 172a. Only one of the rows of rods is shown in the figure. The other row is attached at the rotor part that is to be connected.

The strip 172a is screwed to the disc element, wherein the screw joint also includes a support plate 173 on the opposite side. Support plate 173 is arranged at each end at the circumferential direction at the lower disc 4a only. At the upper disc 4, corresponding support plates are attached at the rotor parts that are to be joined with the rotor part 1a.

The second embodiment of connecting device 18 is found where the disc elements in one and the same rotor part 1a meet each other. It consists of a wall 181 that extends in a radial plane and has a mounting flange 182 at each axial end. Further, there are four axially extending stiffening flanges 183 on each side of the wall 181. The wall 181 has three oval through-holes 184. The mounting flange 182 is screwed to both the disc elements that meet each other along the wall.

When the rotor part 1a is to be connected to the other two rotor parts to form a whole rotor, these are puzzled together in that the protrusions 8 on the rotor part 1a fit into the complementary recesses on the adjacent rotor part and the recesses 9 on the rotor part 1a receive the complementary protrusions on the adjacent rotor part. The corresponding joining is done along respective outer edges on the casing part 3.

Then the upper strip 172 is screwed to each connecting device 17 on a respective support plate (corresponding 173) on the adjacent rotor part. Corresponding connecting devices on the adjacent rotor part are screwed to the support plates 173.

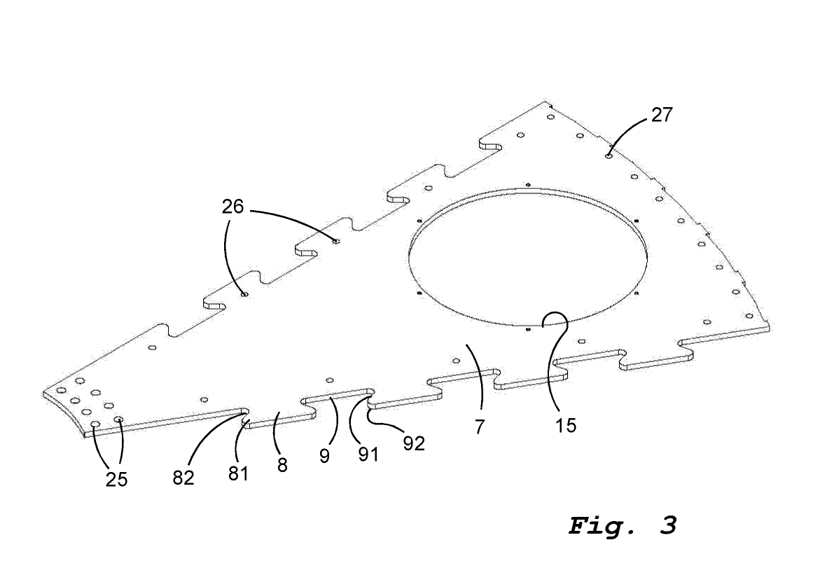

FIG. 3 illustrates in more detail how each disc element is designed. One lateral edge thereof has four protrusions 8 and between them three recesses 9. The other lateral edge has instead four protrusions and three intermediate protrusions. Each protrusion 8 has an outer portion 81 that is wider in the radial direction than a portion 82 thereof closer to the base part of the disc element 7. The protrusions 8 and the recesses 9 have the same shape. The protrusions 8 and recesses 9 of the disc element 7 at its front edge in the figure are shaped to engage the recesses/protrusions into an adjacent disc element with a profile corresponding to the rear edge of the disc element in the figure.

Further, the disc element 7 has a number of screw holes. The radially inner screw holes 25 are intended to attach the disc element 7 at a flange of the rotor shaft. The radially outer screw holes 27 are intended to attach the disc element 7 at a flange on the inside of the casing part. The screw holes 26 are intended to attach the disc elements at the connecting devices 17 or 18 as described above in connection with FIG. 2.

The disc element 7 is cut out by laser cutting. This gives a precision of about 0.01 mm, which ensures a good conformity with good fitting between the protrusions and the recesses.

FIG. 4 illustrates how the casing part is composed of a plurality of layers 3a, 3b, 3c. Each layer is, as described above, composed of casing parts. The joints 31a, 32a, 33a, 34a and 31b, 32b, 33b, 34b and 31c, 32c, 33c, 34c, respectively, between the casing parts are displaced in the peripheral direction so that they are not in the same radial plane anywhere.

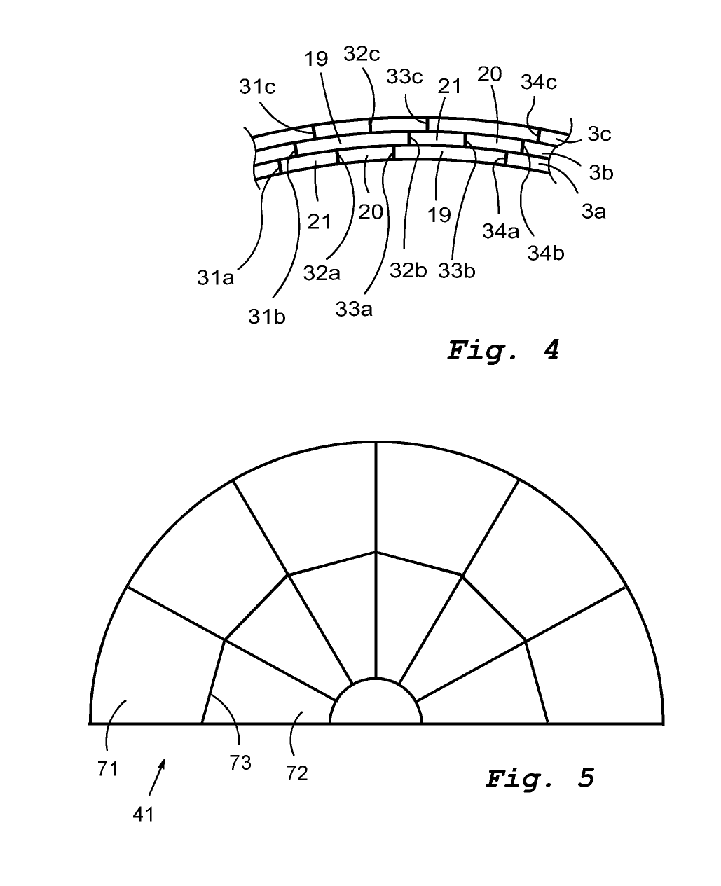

FIG. 5 illustrates an alternative example of a disc 41 of the rotor. The disc in this example is composed of a group of radially outer disc elements 71 and a group of radially inner disc elements 72. The joint 73 between an outer 71 and an inner 72 disc element can be according to the principle for the radially directed joints that have been described above or may be in the form of screw joints.

1. A rotor for an electric generator comprising:
a cylindrical casing part;
a connecting structure arranged to mechanically connect the cylindrical casing part to a rotor shaft;
at least one plane disc comprised in said connecting structure, said at least one plane disc comprising: a plurality of plane disc elements which comprise disc elements which engage lockingly into each other, wherein a respective first and a respective second disc element of said plurality of plane disc elements comprise a complementary shape, where the two discs meet, with at least one protrusion on the first disc element and a corresponding number of recesses at a same position and a complementary shape on the second disc element, wherein a protrusion on the first disc element engages into a recess in the second disc element, and wherein at least one protrusion has a varying width with a first portion closer to the outer end of the protrusion that is wider than a second portion closer to the base part of the disc element for establishing a shape-permanent locking engagement so that a joint is formed between the first and the second disc element.

2. A rotor according to claim 1, wherein the disc is composed in sectors and comprises disc elements that engage into each other along substantially radial lines, wherein each of these disc elements is substantially sector-shaped.

3. A rotor according to claim 1, wherein the disc is sectorally as well as radially assembled and comprises disc elements that engage into each other along substantially radial lines and disc elements that engage into each other along circular lines around a center shaft of the rotor or along tangential lines.

4. A rotor according to claim 1, wherein at least one of the joints comprises a plurality of cooperating protrusions-recesses, wherein at least one of these cooperating protrusions-recesses has said shape-permanent locking engagement.

5. A rotor according to claim 1, wherein the protrusion of said shape-permanent locking engagement is substantially trapezoidal.

6. A rotor according to claim 1, wherein each disc element is provided with protrusions as well as recesses included in a same joint.

7. A rotor according to claim 6, wherein the recesses and the protrusions included in the same joint of a disc element have mutually complementary shape.

8. A rotor according to claim 1, wherein at least two disc elements have mutually the same shape and size.

9. A rotor according to claim 1, wherein at least some of the disc elements exhibit at least one through hole.

10. A rotor according to claim 1, wherein the connecting structure comprises two discs at an axial distance from each other.

11. A rotor according to claim 10, wherein the discs are located at the same distance from a respective axial end of the rotor and that said distance is less than the axial distance between the discs.

12. A rotor according to claim 10 wherein a plurality of radially extending partition walls connect the two discs to each other.

13. A rotor according to claim 1, wherein screw joints connect disc elements to each other.

14. A rotor according to claim 1, wherein the cylindrical casing part comprises at least one casing layer comprising a plurality of arc-like casing parts that engage lockingly into each other, wherein a respective first and a respective second casing part comprise a complementary shape, where the two discs meet, with at least one protrusion on the first casing part and a corresponding number of recesses of a complementary shape and at a same position on the second casing part, wherein a protrusion on the first casing part engages into a recess in the second casing part, which recess has the same shape as the protrusion and wherein at least one protrusion has a varying width with a portion closer to the outer end of the protrusion that is wider than a portion closer to the base part of the casing part for establishing a shape-permanent locking engagement so that a joint is formed between the first and the second casing part.

15. A rotor according to claim 14, wherein the casing part comprises a plurality of said casing layers, which abut each other.

16. A rotor according to claim 15, wherein the joints of a casing layer are located displaced in the peripheral direction in relation to the joints of the closest adjacent casing layer.

17. A rotor according to claim 15, wherein screw joints connect casing parts with each other.

18. A rotor according to claim 1 further comprising a plurality of circumferentially distributed, removable dismantling joints.

19. A rotor according to claim 1, wherein a diameter of the rotor is larger than 2 m.

20. An electric generator comprising a rotor comprising:
a cylindrical casing part;
a connecting structure arranged to mechanically connect the cylindrical casing part to a rotor shaft;
at least one plane disc comprised in said connecting structure, said at least one plane disc comprising: a plurality of plane disc elements which comprise disc elements which engage lockingly into each other, wherein a respective first and a respective second disc element of said plurality of plane disc elements comprise a complementary shape, where the two discs meet, with at least one protrusion on the first disc element and a corresponding number of recesses at a same position and a complementary shape on the second disc element, wherein a protrusion on the first disc element engages into a recess in the second disc element, and wherein at least one protrusion has a varying width with a first portion closer to the outer end of the protrusion that is wider than a second portion closer to the base part of the disc element for establishing a shape-permanent locking engagement so that a joint is formed between the first and the second disc element.

21. A method for manufacturing a rotor for an electric generator, wherein said rotor comprises a casing part and a connection structure arranged to mechanically connect the casing part with a rotor shaft, which structure comprises at least one plane disc, said method comprising:
providing a plurality of plane disc elements with a respective profile so that the disc elements can be put together like a puzzle, where a respective first and a respective second disc element of said plurality of plane disc elements comprise complementary shapes in that the first disc element comprises at least one protrusion and the second disc element comprises a corresponding number of recesses of the same shape and at a complementary position and where at least one protrusion has a varying width with a first portion closer to the outer end of the protrusion which is broader than the second portion closer to the base part of the disc element, and which disc elements together form a circular disc with center hole;
joining the disc elements into a circular disc by inserting protrusions in a puzzle-like manner into complementary recesses so that they engage lockingly into each other in a shape-permanent joint;
attaching a rotor shaft in the hole; and
attaching a cylindrical body around the disc to form a casing part.

22. A method according to claim 21 further comprising manufacturing the plurality of plane disc elements by cutting them out from plane discs.

23. A method according to claim 22, wherein said manufacturing the disc elements comprise cutting out the disc elements by laser cutting.

24. (canceled)
